(19) United States
(12) Patent Application Publication
(10) Pub. No.: US 2024/0144145 A1
(43) Pub. Date: May 2, 2024

(54) REAL-TIME KEY PERFORMANCE INDICATOR

(71) Applicant: Christopher Michael Conrad, Smithfield, NC (US)

(72) Inventor: Christopher Michael Conrad, Smithfield, NC (US)

(21) Appl. No.: 17/975,930

(22) Filed: Oct. 28, 2022

(51) Int. Cl. G06Q 10/06; G06Q 10/10

(52) U.S. Cl. CPC G06Q 10/06393; G06Q 10/10

(57) ABSTRACT

A computer system and program designed to use a code segment which provides associated content items from a business related software database to provide a user with Key Performance Indicators in real time.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a computer system and a computer program for the management of a business related software in order to provide real-time Key Performance Indicators (KPI).

### Description of Related Art

The competitiveness of searching for customers and improving interactions with them has provided technological solutions. One such solution involves business related software, which involves managing the relationship with a customer, including all aspects of the relationship from sales to advertising, and the like. Technology allows for a company to utilize a computer system to keep track of the various aspects of business related software. These systems allow a company to manage the business related software process as long as sufficient data is present. However, management takes time and evaluation of the data in a business related software is not done in real-time and, therefore, can only be applied at a later date. Customer satisfaction is an important indicator of a company's success and a real-time software is critical in gaining and retaining customers.

### BRIEF SUMMARY OF THE INVENTION

The present invention relates to a computer system and program designed to produce KPI's from a user's business related software. Information can be obtained by utilizing an application programing interface, or the like.

Accordingly, in one embodiment, there is a computer program on a computer-readable non-transitory medium for execution by a computer to produce Key Performance Indicators (KPI) from business related software comprising:
a) a code segment providing a database comprising a plurality of content items obtained from the user's business related software via an interface;
b) a code segment for providing association between the content items;
c) a code segment for providing Key Performance Indicators from the associated content items; and
d) a code segment for providing the user with the Key Performance Indicators.

In another embodiment, there is a computer system for supporting a user's business related software comprising:
a) a database comprising a plurality of content items obtained from the user's business related software via an interface;
b) a processor; and
c) a memory containing instructions, that when executed, perform a method comprising:
   i. providing a database comprising a plurality of content items obtained from the user's business related software via an interface;
   ii. providing association between the content items;
   iii. providing Key Performance Indicators from the associated content items; and
   iv. providing the user with the Key Performance Indicators.

### BRIEF DESCRIPTION OF THE DRAWINGS

FIG. 1 is a computer program chart for managing business related software of the present invention.

FIG. 2 is a computer system for managing business related software of the present invention.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “computer program” refers to a computer program or a portion thereof, and may include associated data. A computer program may be an independent program, or it may be designed to provide one or more features to another application. An “add-in” and a “plug-in” are examples of computer programs that interact with and provide features to a “host” application. A computer program is made up of any combination of program components, which may include program instructions, data, text, object code, images or other media, security certificates, scripts, or other software components that may be installed on a computing device to enable the device to perform desired functions. Program components may exist in the form of files, libraries, pages, binary blocks, or streams of data, but are not limited to, the following: a server computing system; a workstation; a desktop computing system; a mobile computing system, including, but not limited to, smart phones, portable devices, and/or devices worn or carried by a user; a database system or storage cluster; a virtual asset; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the term “computer-readable non-transitory medium” refers to both storage media and communications media. Communications media typically embody computer-readable instructions, data structures, program modules, or other data in a modulated data signal, such as a carrier wave or other transport mechanism and include any information-delivery media. By way of example, and not limitation, communications media include wired media, such as wired networks and direct-wired connections, and wireless media such as acoustic, radio, infrared, and other wireless media.

As used herein, the term “support” refers to the computer program and the computer system taking the business information of a user and using it to generate a desired KPI.

As used herein, the term “user” refers to denote any party and/or entity that interfaces with, and/or to whom information is provided by, the disclosed methods and systems described herein, and/or a person and/or entity that interfaces with, and/or to whom information is provided by, the disclosed methods and systems described herein, and/or a legal guardian of person and/or entity that interfaces with, and/or to whom information is provided by, the disclosed methods and systems described herein, and/or an authorized agent of any party and/or person and/or entity that interfaces with, and/or to whom information is provided by, the disclosed methods and systems described herein. For instance, in various embodiments, a user can be, but is not limited to, a person, a commercial entity, an application, a service, and/or a computing system.

As used herein, the term “business related software” refers to a technology for managing all of a company's business relationships and interactions with customers and potential customers. The goal is simple: Improve business relationships to grow your business. It includes the combination of practices, strategies, and technologies that companies use to manage and analyze customer interactions and data throughout the customer lifecycle. For example, Customer Relationship Management (CRM), Enterprise Resource Planning (ERP), finance, sales/marketing, and the like or any other current or future business related software.

As used herein, the term “code segment” refers to a process, function, subprogram, program, routine, subroutine, module, software group, type, or any combination of instructions, data structures, and program statements. A code segment may be coupled with another code segment or a hardware circuit.

As used herein, the term “database” refers to an organized collection of structured information, or data, typically stored electronically in a computer system. A database is usually controlled by a database management system (DBMS).

As used herein, the term “content items” refers to items within the business related software that identify results associated with the use of the business related software.

As used herein, the term “interface” refers to, is part of, or includes circuitry providing for the exchange of information between two or more components or devices. The term “interface circuitry” may refer to one or more hardware interfaces (for example, buses, input/output (I/O) interfaces, peripheral component interfaces, network interface cards, and/or the like). In some embodiments, the term “interface” or “interface circuitry” may include a processor and a memory device.

As used herein, the term “association between the content items” refers to the determination of which part that each of the content items relate to the other content items.

As used herein, the term “key performance indicators (KPI)” refers to a quantifiable measure used to evaluate the success of an organization, employee, etc. in meeting objectives for performance developed from a user's business related software.

As used herein, the term “computer system” can denote, but is not limited to the following: systems made up of multiple virtual assets, server computing systems, workstations, desktop computing systems, mobile computing systems, database systems or storage clusters, switching systems, routers, hardware systems, communications systems, proxy systems, gateway systems, firewall systems, load balancing systems, or any devices that can be used to perform the processes and/or operations as described herein.

As used herein, the term “processor” refers to, is part of, or includes circuitry capable of sequentially and automatically carrying out a sequence of arithmetic or logical operations; recording, storing, and/or transferring digital data.

The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes.

As used herein, the term “interface” may refer to, is part of, or includes circuitry providing for the exchange of information between two or more components or devices. The term “interface” may refer to one or more hardware interfaces (for example, buses, input/output (I/O) interfaces, peripheral component interfaces, network interface cards, and/or the like.

As used herein, the term “memory” refers to any type of integrated circuit or other storage device adapted for storing digital data including, without limitation, read-only memory (ROM), programmable read-only memory (PROM), electrically erasable programmable read-only memory (EEPROM), dynamic random access memory (DRAM), Mobile DRAM, synchronous dynamic random access memory (SDRAM), double data rate synchronous dynamic random-access memory (DDR/2 SDRAM), extended data out/fast page mode (EDO/FPMS), reduced latency dynamic random access memory (RLDRAM), static random access memory (SRAM), “flash” memory (e.g., NAND/NOR), memristor memory, and pseudo static random-access memory (PSRAM).

As used herein, the term “wireless” means any wireless signal, data, communication, or other interface including without limitation Wi-Fi®, wireless technology, 3G (3GPP/3GPP2), high speed downlink packet access/high speed uplink packet access (HSDPA/HSUPA) time division multiple access (TDMA), code division multiple access (CDMA) (e.g., interim standard (IS-95A), wideband code division multiple access (WCDMA), etc.), frequency-hopping spread spectrum (FHSS), direct-sequence spread spectrum (DSSS), global system for mobile communications (GSM), personal area network (PAN/802.15), WiMAX (802.16), 802.20, narrowband/frequency division multiple access (FDMA), orthogonal frequency-division multiplexing (OFDM), personal communications service (PCS)/distributed control system (DCS), long-term evolution (LTE)/LTE-NTD-LTE, analog cellular, cellular digital packet data (CDPD), satellite systems, millimeter wave or microwave systems, acoustic, and infrared (i.e., infrared data association (IrDA)).

As used herein, the term “instructions” refers to detailed information telling how something should be done, operated, or assembled that can be communicated to a processor.

As used herein, the term “network” includes, but is not limited to, any network or network system such as, but not limited to, the following: a peer-to-peer network; a hybrid peer-to-peer network; a Local Area Network (LAN); a Wide Area Network (WAN); a public network, such as the Internet; a private network; a cellular network; any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “content items” refers to the data items in the database that are extracted by the present technology.

### Drawings

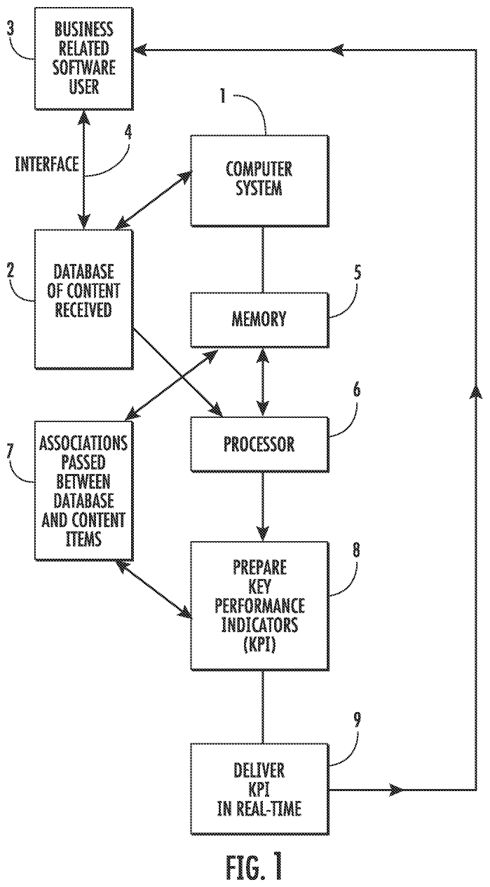

Now referring to the drawings, FIG. 1 is a graphic representation of the computer system 1 of the present invention. In this view, the computer system 1 comprises a database of content received 2 from a business related software user 3 via use of an interface 4. Data is held in a memory 5 and a processor 6 creates an association 7 between database of content items 2. The processor 6 can then prepare Key Performance Indicators (KPI) 8 from the association 7 between database of content items 2. The computer system 1 then delivers the KPI in real-time 9 to business related software user 3.

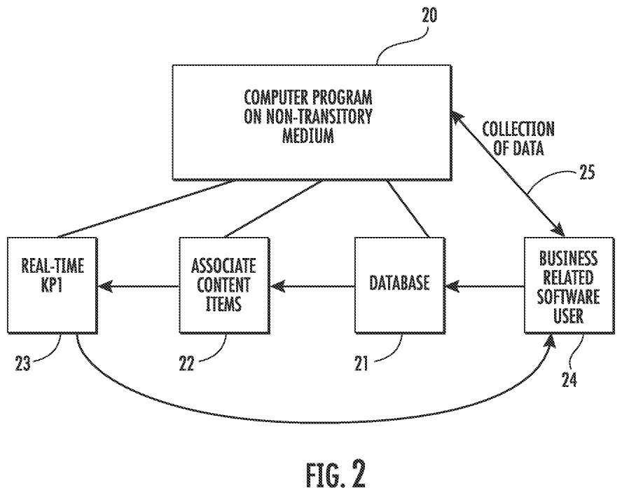

FIG. 2 depicts the computer program on non-transitory medium 20. The computer program 20 has code segments which collect data 25 from business related software user 24 and place the data in database 21. Another code segment associates the content items 22 of the database 21 and creates real-time KPI 23, which is delivered to business related software user 24.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A computer program on a computer-readable non-transitory medium for execution by a computer to produce Key Performance Indicators (KPI) from business related software comprising:
a) a code segment providing a database comprising a plurality of content items obtained from the user's business related software via an interface;
b) a code segment for providing association between the content items;
c) a code segment for providing Key Performance Indicators from the associated content items; and
d) a code segment for providing the user with the Key Performance Indicators.

2. A computer system for supporting a user's business related software comprising:
a) a database comprising a plurality of content items obtained from the user's business related software via an interface;
b) a processor; and
c) a memory containing instructions, that when executed, perform a method comprising:
i. providing a database comprising a plurality of content items obtained from the user's business related software via an interface;
ii. providing association between the content items;
iii. providing Key Performance Indicators from the associated content items; and
iv. providing the user with the Key Performance Indicators.
